(19) United States
(12) Patent Application Publication
(10) Pub. No.: US 2009/0168080 A1
(43) Pub. Date: Jul. 2, 2009

(54) Poster printing control module, method of poster printing control, and multi-functional printer

(76) Inventors: Cheng-Yuan Chen, Taipei City (TW); Jui-Yang Huang, Taoyuan City (TW); Lin-Ying Huang, Pingjhen City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/076,965

(22) Filed: Mar. 26, 2008

(30) Foreign Application Priority Data
Dec. 28, 2007 (TW) 96151004

(51) Int. Cl. G06K 15/00

(52) U.S. Cl. 358/1.2

(57) ABSTRACT

A method of poster printing control, applicable to a multi-functional printer, comprising at least one printing module and a scanning module, includes using a scanning module to scan an original paper to obtain a digital copy of known size; setting a size of a paper to be printed; dividing the digital copy into a plurality of sub-images; up-scaling the sub-images to the size of the paper to be printed; using the printing module to print out the sub-images on the paper to be printed. Thereby, the poster printing is completed by means of the multi-functional printer.

### BACKGROUND OF THE INVENTION

1. Field of the Invention

The invention generally relates to a poster printing control module and a method of poster printing control, and more particularly to a poster printing control module and a method of poster printing control by using a multi-functional printer.

2. Description of the Related Art

Currently most posters are layout by plotters which cost high and have complicate operations. Sine the plotters need expertise to operate, which are not suitable for commercial officer, staff or end users to use.

Another way to layout the posters is to use a computer with a scanner and a printer to input scanned images of the posters to the computer. The computer is usually installed with a poster production software which helps the user control the process of poster printing including the input and layout of the scanned images of the posters.

However, the conventional methods of printing the posters must be implemented along with relevant equipment having poster production software. This poster production software costs extra. Even though the operational system of the commercial available computer has document editing software or briefing software to provide some functions similar to the poster production software, still its interface could not work out for more complicate requirement. For example, when an original document is to be scaled up to four times and printed on 4 corresponding papers, the user should calculate the starting/ending points and the amplification rate for each scanned part of the original document. The result from the manual calculation will not be accurate enough and such a calculation brings inconvenience in use.

### SUMMARY OF THE INVENTION

An object of the invention is to provide a poster printing control module and a method of poster printing control, which overcome the prior problems. The invention allows the user to have the poster to be printed via the multi-functional printer, without any need of computer or plotter. Furthermore, the operational calculation implemented inside the multi-functional printer contributes to simplified operation for the user.

In order to achieve the above and other objectives, the method of poster printing control according to the invention, applicable to a multi-functional printer comprising at least one printing module and a scanning module, includes scanning an original paper to obtain a digital copy of known size; equally dividing the digital copy into a plurality of sub-images; setting a size of paper to be printed; and up-scaling the sub-images. The up-scaling is performed by retrieving the sub-images, individually scaling up the digital copies which are then layout on the paper to be printed via the printing module. The amplification rates for up-scaling the sub-images are obtained based on the size of the paper to be printed and the size of one of the sub-images.

In the embodiments of the invention, the sub-images are scaled up in turns, and stored in the same register module.

In the embodiments of the invention, the amplification rates are obtained by dividing the size of the paper to be printed by the size of one of the sub-images.

The invention also provides a poster printing control module, applicable to a multi-functional printer comprising at least one printing module and a scanning module, includes a paper setting module, used to set the size of a paper to be printed by the printing module; a dividing module, used to equally divide a digital copy of an original paper of known size into parts; an image scale-up module, used to scale up the sub-images; a calculating module, used to calculate the amplification rates for up scaling the sub-images; and a processor module, used to control the paper setting module, the dividing module, the image scale-up module and the calculating module, wherein the processor module deals with the up-scaling of the sub-images. The scanning module is driven to scan the original paper to obtain the digital copy which is divided and scaled up by the amplification rates and then printed onto the paper to be printed via the printing module.

In the embodiments of the invention, the sub-images are scaled up in turns, and stored in the register module.

The user can have the poster printed by means of easy operation of the multi-functional printer, without any need of computer or printing software.

To provide a further understanding of the invention, the following detailed description illustrates embodiments and examples of the invention, this detailed description being provided only for illustration of the invention.

### BRIEF DESCRIPTION OF THE DRAWINGS

FIG. 1 is a block diagram of a multi-functional printer according to one embodiment of the invention;

FIG. 2 is a block diagram of a multi-functional printer according to one embodiment of the invention;

FIG. 3A through FIG. 3G are schematic views of a method of poster printing control according to one embodiment of the invention; and

FIG. 4 is a flow chart of a method of poster printing control according one embodiment of the invention.

### DETAILED DESCRIPTION OF THE EMBODIMENTS

Wherever possible in the following description, like reference numerals will refer to like elements and parts unless otherwise illustrated.

The invention provides a poster printing control module and a method of controlling the poster printing. The invention can be applied to a multiple-functional printer to layout posters. User-friendly operation allows the user to easily print the posters out without considering how the printer works on its own. In addition, less memory is needed while the printer is working.

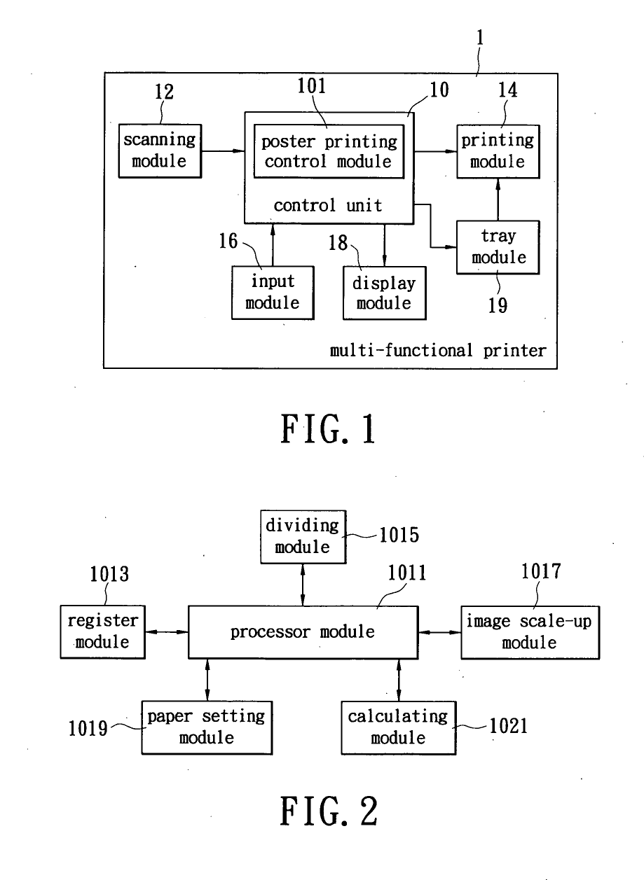

FIG. 1 is a block diagram of a multiple-functional printer according to one embodiment of the invention. The multiple-functional printer 1 includes a control unit 10, a scanning module 12, a printing module 14, an input module 16, a display module 18 and a tray module 19. The control unit 10 is a core of the multiple-function module 1 which is in charge of dealing with various duties and managing work loads. The control unit 10 further has a poster printing control module 101 which is coupled between the scanning module 12 and the printing module 14. The multiple-functional printer 1 offers the function of poster printing via the poster printing control module 101.

The scanning module 12, the printing module 14, the input module 16, the display module 18 and the tray module 19 start working depending on demands from the poster printing control module 101. For example, the scanning module 12 scans an original paper while printing out a poster. The printing module 14 prints out the content of the poster on a paper. The input module 16 has buttons or touch panel for the user to control the poster printing control module 101. The tray module 19 provides papers of different sizes for the printing module 14 to layout the posters. The display module 18 has a LED or display panel to indicate the work status of poster printing.

Details of the scanning module 12, the printing module 14, the input module 16, the display module 18 and the tray module 19 rather than the poster printing are not within the scope of the invention, and will be omitted here below.

The embodiment of the multiple-functional printer according to the invention as shown in FIG. 1 is illustrative. It is known that the complete configuration includes other basic implementing elements, such as a fax module (not shown), which are not related to the invention and will not be mentioned in detail below.

FIG. 2 is a block diagram of a poster printing control module 101 according to one embodiment of the invention. The poster printing control module 101 includes a processor module 1011, a register module 1013, a dividing module 1015, an image scale-up module 1017, a paper setting module 1019 and a calculating module 1021. The processor module 1011 is respectively coupled to the register module 1013, the dividing module 1015, the image scale-up module 1017, the paper setting module 1019 and the calculating module 1021, and therefore used to control those modules. The processor 1011 scans the original paper via the scanning module 1013 for outputting the poster. The control module 14 outputs several layouts which can form integrally a complete poster.

The register module 1013 provides memory for temporarily store all data needed for poster printing under the control of the processor module 1011. The data can be the scanned images from the scanning module 12. For example, the scanning module 12 scans the original paper and then stores digital images thereof into the register module 1013. The register module 12 is preferably a RAM or other storage devices.

The dividing module 15 divides the digital copy of the original paper in the register module 1013 under the control of the processor module 1011. The digital copy can be divided into a plurality of sub-images so that the processor module 1011 can process those sub-images individually.

The image scale-up module 1017 respectively scales up the sub-images under the control of the processor module 1011. Those up-scaled sub-images are printed out by via the printing module 14.

The paper setting module 1019 is used to set the paper size for the printing module 14 under the control of the processor module 1011, so that the processor module 1011 drives the tray module 19 to provide the paper of proper size for the printing module 14 to layout those sub-images according to the paper setting of the module 1019. Furthermore, the size of the paper to be printed, set by the paper setting module 1019 in this embodiment, is illustrative for the printing module 14.

The calculating module 1021 is used to calculate the amplification rate of scaling up the sub-images by the image scale-up module 1017 under the control for the processor module 1011. The calculating module 1021 determines the amplification rate based on the dimensions of the sub-images and the setting of the paper setting module 1019. For example, the sub-images has A/2 in length and B/2 in width, and the paper size set by the paper setting module 1019 is A in length and B in width. The result of amplification rates obtained from the calculating module 1021 is (A/(A/2)=2 for length and (B/(B/2)=2 for width, which are provided to the processor module 1011 to control the image scale-up module 1017 for proceeding the sub-images up-scaling accordingly.

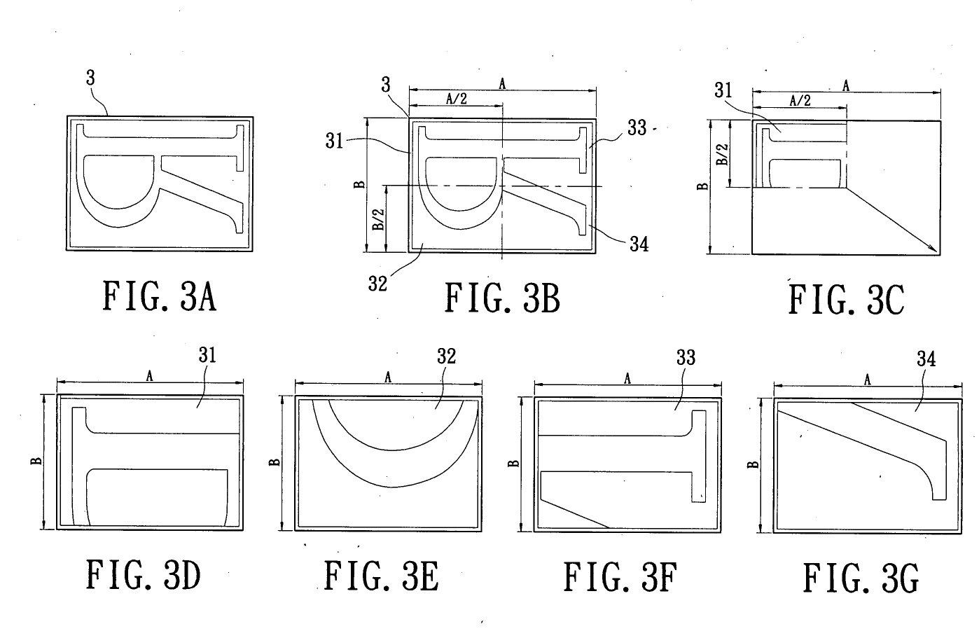

FIG. 3A through FIG. 3G illustrate the process of poster printing control by using the poster printing control module according to one embodiment of the invention. In this embodiment, an original paper 3 is placed onto the scanning module 12 to scan. The original paper 3 as shown in FIG. 3A has length A and width B. The scanning module 12 in this embodiment has a flatbed. The paper 3 is placed in a manner to align with a starting line where scanning beams start to sweep, so that the size of paper 3 can be measured in subsequent procedure. Under the control of the processor module 1011, the scanning module 12 is driven to pre-scan the paper 3 and store accordingly the digital image of the paper 3 into the register module 1013. The processor module 1011 obtains the size of the paper 3 according to the digital image by scanning the paper 3.

The dividing module 1015 divides the obtained digital copy into equal parts (2×2, for example). As shown in FIG. 3B, four sub-images 31, 32, 33, 34 are obtained, each of which has length A/2 and width B/2. It is assumed that the paper setting module 1019 sets the length of the paper as A and the width as B. The calculating module 1021 divides the size of the paper to be printed by the size of one of the sub-images to obtain the amplification rate for scaling up the sub-images.

The processor module 1011 deals with the scale-up process according to the obtained amplification rate. The processor module 1011 drives the scanning module 12 again to scan in turns the sub-images 31, 32, 33, 34 as shown in FIG. 3B. First, the scanning module 12 scans the sub-image 31 and obtains a digital copy thereof which is then stored into the register module 1013. Then, the image scale-up module 1017 doubles the digital copy of the sub-image 31 in size. The printing module 14 layouts the up-scaled image on the paper of set size. As shown in FIG. 3D, digital copies of the sub-images 32, 33, 34 are obtained in turns in the way similar to the sub-image 31, and layout to the paper of set size as shown in FIG. 3E through FIG. 3G.

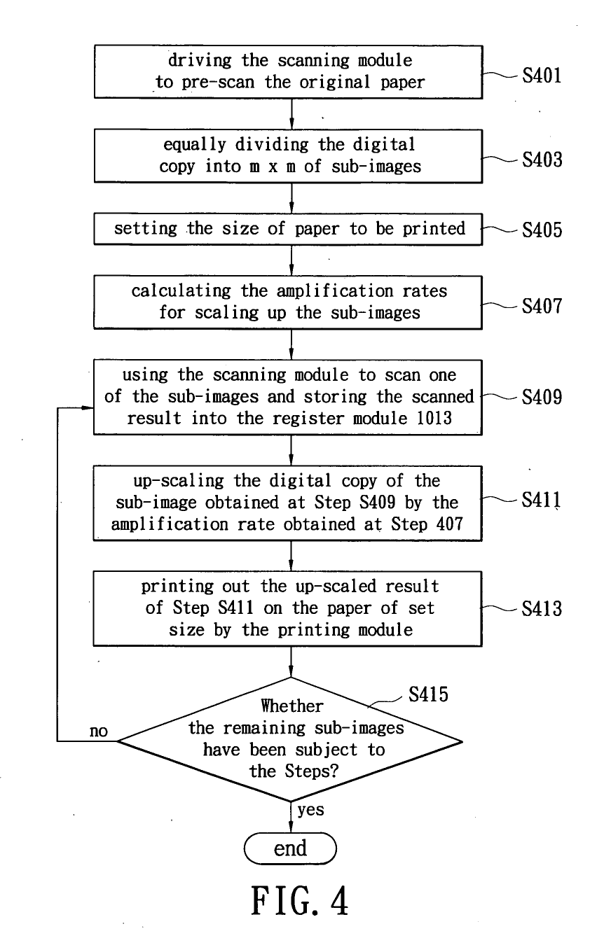

FIG. 4 is a flow chart of a method of poster printing control according one embodiment of the invention. The apparatus used to implement the method is similar to those shown in FIG. 1 and FIG. 2. An original paper is placed onto the scanning flatbed of the scanning module 12 before the poster printing function is triggered. The method has the following steps.

The scanning module 12 is driven to pre-scan the original paper (Step S401). A digital image is obtained and then stored into the register module 1013. It is intended to get the size of the original paper at this step and therefore it is not necessary to get digital image of high quality. In this embodiment, the scanning module 12 is driven to scan with low resolution. The term “low resolution” means the resolution lower than the highest default of the scanning module 12. It is preferable to choose the lowest resolution for scanning, because the scanning with lowest resolution uses least memory, resulting in higher scanning speed.

Subsequently, equally dividing the digital copy of the original paper into m×m of sub-images (Step S403). Then, the size of paper on which the printing module 19 layouts is set (Step S405). The amplification rates for scaling up the sub-images are calculated (Step S407). The amplification rates are obtained by dividing the size of the paper to be printed by the size of one of the sub-images.

The scanning module 12 scans one of the sub-images (Step S409) and stores the scanned result into the register module 1013. The resolution used at this step is the normal resolution or the highest one in order to make sure the quality of the scanned image. The digital copy of the sub-image obtained at Step S409 is scaled up by the amplification rate obtained at Step 407 (Step S411). The printing module 19 prints the up-scaled result of Step S411 on the paper of set size (Step S413).

After the Step S413 is finished, it is judged whether the remaining sub-images have been subject to the Steps S409-S413 (Step S415). If NO, then go back to Step S409 to run Step S409-S413 over the remaining sub-images. If YES, then end the process.

The Step S401 can be carried out in another way. For example, when the size of the original paper is known, it can be input to the poster printing control module 101 via the input module 16

Furthermore, Step S401 provides a quick scanning for pre-scanning, which saves the memory need for the register module 1013 and therefore save the hardware cost. The sub-images of equal size are scaled up individually via Step S409-S413. Therefore, the register module 1013 repeats the scanning of the sub-images by using limited memory. In other words, there is no need for the register module 1013 to offer big memory for the poster printing.

In light of the foregoing, the poster printing control module 101 and the method of poster printing control allow the user to easily control the poster printing on the multi-functional printer 1. Only by means of triggering the poster printing function, properly placing the original paper on the scanning flatbed and setting the size of the paper to be printed, the poster printing control module 101 inside the multi-functional printer automatically finishes the layout of the poster. It is noted that the invention uses less memory to implement the poster printing, significantly reducing the manufacturing cost for the multi-functional printer 1.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A method of poster printing control, applicable to a multi-functional printer comprising at least one printing module and a scanning module, the method comprising:
equally dividing an original paper of known size into a plurality of sub-images;
setting a size of paper to be printed; and
up-scaling the sub-images,
wherein the up-scaling is performed by scanning the original paper, individually scaling up the digital copy thereof which are then printed on the paper to be printed via the printing module;
wherein the amplification rates for up-scaling the sub-images are obtained based on the size of the paper to be printed and the size of one of the sub-images.

2. The method of poster printing control of claim 1, wherein the original paper is divided into m×m equal parts.

3. The method of poster printing control of claim 1, wherein the original paper is placed on a flatbed of the scanning module.

4. The method of claim 1, wherein the size of the paper to be printed is the one the printing module supports.

5. The method of poster printing control of claim 1, further comprising a step of the scanning module pre-scanning the original paper to get the size of the original paper.

6. The method of poster printing control of claim 5, wherein the scanning module uses a pre-scanning resolution smaller than the highest default of the scanning module.

7. The method of poster printing control of claim 1, further comprising a step of receiving the size of the original paper input by the user.

8. The method of poster printing control of claim 1, wherein the sub-images are scaled up in turns, and then stored in the register module.

9. The method of poster printing control of claim 1, wherein the amplification rates are obtained by dividing the size of the paper to be printed by the size of one of the sub-images.

10. A poster printing control module, applicable to a multi-functional printer comprising at least one printing module and a scanning module, the poster printing control module comprising:
a paper setting module, used to set a paper to be printed by the printing module;
a dividing module, used to equally divide an original paper of known size into sub-images;
an image scale-up module, used to scale up the sub-images;
a calculating module, used to calculate the amplification rates for up scaling the sub-images; and
a processor module, used to control the paper setting module, the dividing module, the image scale-up module and the calculating module, wherein the processor module deals with the up-scaling of the sub-images;
wherein the scanning module is driven to scan the original paper to obtain a digital copy which is divided equally and scaled up by the amplification rates and then printed onto the paper to be printed via the printing module.

11. The poster printing control module of claim 10, wherein the dividing module divides the original paper into m×m equal parts.

12. The poster printing control module of claim 10, wherein the size of the paper to be printed is that the printing module supports.

13. The poster printing control module of claim 10, wherein the size of the original paper is obtained by using the processor module to drive the scanning module to pre-scans the original paper.

14. The poster printing control module of claim 13, wherein the scanning module uses a pre-scanning resolution smaller than the highest default of the scanning module

15. The poster printing control module of claim 10, wherein the sub-images are scaled up in turns, and stored in the register module.

16. The poster printing control module of claim 10, wherein the amplification rates are obtained by dividing the size of the paper to be printed by the size of one of the sub-images.

17. A multi-functional printer having the poster printing control module as defined in claim 10, wherein the poster printing control module is coupled between the scanning module and the printing module.
